(19) United States
(12) Patent Application Publication
(10) Pub. No.: US 2022/0200296 A1
(43) Pub. Date: Jun. 23, 2022

(54) BATTERY PROTECT CIRCUIT AND BATTERY MODULE

(71) Applicant: YT ELECTRONICS LTD., Taipei City (TW)

(72) Inventor: Yu-Ta TSENG, Taipei City (TW)

(21) Appl. No.: 17/553,926

(22) Filed: Dec. 17, 2021

Related U.S. Application Data
(60) Provisional application No. 63/126,586, filed on Dec. 17, 2020.

(51) Int. Cl. H02J 7/00; H01M 50/574; H01M 10/42

(52) U.S. Cl. CPC H02J 7/0031; H02J 7/00306; H02J 7/00302; H01M 2010/4271; H01M 10/425; H02J 7/0013; H02J 7/0063; H01M 50/574

(57) ABSTRACT

A battery protection circuitry comprises a first control component, a first over-discharged protect switch and a second over-discharged protect switch. The first control component is configured to couple to a battery pack to read voltage values of each battery in the battery pack. The first over-discharged protect switch has a first end configured to couple to a negative pole of the battery pack, and a second end. The second over-discharged protect switch has a third end coupled to the second end. When a voltage value of any battery in the battery pack is less than an over-discharged default voltage, the first control component controls the second over-discharged protect switch to be disconnected prior to the first over-discharged protect switch. Wherein the voltage tolerance of the second over-discharged protect switch is higher than the voltage tolerance of the first over-discharged protect switch.

### FIELD OF THE INVENTION

The disclosure is relative to a battery protection circuitry and a battery module; in particular, a battery protection circuitry and a battery module having two types of over-discharged protect switches.

### BACKGROUND OF THE INVENTION

In order to pursue better convenience and portability, more and more electronic devices will use battery configuration. In order to achieve desired voltage and/or power, multiple battery cells are integrated into a battery pack by series and/or parallel. when the required voltage or power is too large, the specification of the protection circuit of the battery pack will increase accordingly (for example, higher specification active components or passive components are required). Therefore, the cost of battery protection circuitry will increase.

Besides, in some cases, in order to satisfy safety requirements or regulations, the battery pack also needs to qualify higher protection effects. Accordingly, the battery protection circuitry also requires higher specification components or more components. It also causes the cost of battery protection circuitry increasing.

Hence, how to protect the battery pack within the required safety specifications with desired voltage and/or power, without increasing the cost will be a major issue of the development of battery protection circuitry.

### SUMMARY OF THE INVENTION

In an embodiment, a battery protection circuitry comprises a first control component, a first over-discharged protect switch and a second over-discharged protect switch. The first control component is configured to couple to a battery pack to read voltage values of each battery in the battery pack. The first over-discharged protect switch has a first end configured to couple to a negative pole of the battery pack, and a second end. The second over-discharged protect switch has a third end coupled to the second end. When a voltage value of any battery in the battery pack is less than an over-discharged default voltage, the first control component controls the second over-discharged protect switch to be disconnected prior to the first over-discharged protect switch. Wherein the voltage tolerance of the second over-discharged protect switch is higher than the voltage tolerance of the first over-discharged protect switch.

In an embodiment, a battery protection circuitry comprises the first control component, the first over-discharged protect switch, the second control component and the second over-discharged protect switch. The first control component is configured to couple to the battery pack to read voltage value of each battery in the battery pack. The first over-discharged protect switch has the first end configured to couple to the negative pole of the battery pack, and the second end. The second control component is configured to couple the battery pack to read the voltage values of each battery in the battery pack. The second over-discharged protect switch has the third end coupled to the second end. when a voltage value of any battery in the battery pack is less than a first over-discharged default voltage, the first control component controls the first over-discharged protect switch to be disconnected. When a voltage value of any battery in the battery pack is less than a second over-discharged default voltage, the second control component controls the second over-discharged protect switch to be disconnected. Wherein the second over-discharged default voltage is larger than the first over-discharged default voltage.

In an embodiment, a battery module comprises a battery pack and one of the aforementioned battery protection circuitries.

By using two or more over-discharged protect switches (turn off successively or different specifications), it can provide better protection to the battery pack coupled to the battery protection circuitry (for example, one of the over-discharged protect switches can be backup or auxiliary), and will not increase the cost of power circuit due to the requirements of safety regulations.

### BRIEF DESCRIPTION OF THE DRAWINGS

FIG. 1A is a schematic view of the battery protection circuitry according to the first embodiment of the present invention.

FIG. 1B is a schematic view of voltage distribution after circuit disconnection according to the first embodiment of the present invention.

FIGS. 2A-2B are a schematic view of the battery protection circuitry according to the second embodiment of the present invention.

FIG. 3 is a schematic view of the battery protection circuitry according to the third embodiment of the present invention.

FIGS. 4A-4C are a schematic view of the battery protection circuitry according to the fourth embodiment of the present invention.

FIG. 5 is a schematic view of battery module according to fifth embodiment of the present invention.

The accompanying drawings are presented to aid in the description of various aspects of the disclosure and are provided solely for illustration of the aspects. In order to simplify the drawings and highlight the contents to be presented in the drawings, the well-known structures or elements in the drawings may be drawn in a simple schematic manner or presented in an omitted manner. For example, the number of elements may be singular or plural. These drawings are provided only to explain these aspects and not to limit thereof.

### DETAILED DESCRIPTION OF THE PREFERRED EMBODIMENTS

It should be understood that, even though the terms such as “first”, “second”, “third” may be used to describe an element, a part, a region, a layer and/or a portion in the present specification, but these elements, parts, regions, layers and/or portions are not limited by such terms. Such terms are merely used to differentiate an element, a part, a region, a layer and/or a portion from another element, part, region, layer and/or portion. Therefore, in the following discussions, a first element, portion, region, portion may be called a second element, portion, region, layer or portion, and do not depart from the teaching of the present disclosure. The terms “comprise”, “include” or “have” used in the present specification are open-ended terms and mean to “include, but not limit to.”

As used herein, the term “coupled to” in the various tenses of the verb “couple” may mean that element A is directly connected to element B or that other elements may be connected between elements A and B (i.e., that element A is indirectly connected with element B).

The terms “about”, “approximate” or “essentially” used in the present specification include the value itself and the average values within the acceptable range of deviation of the specific values confirmed by a person having ordinary skill in the present art, considering the specific measurement discussed and the number of errors related to such measurement (that is, the limitation of the measurement system). For example, “about” may mean within one or more standard deviations of the value itself, or within ±30%, ±20%, ±10%, ±5%. In addition, “about”, “approximate” or “essentially” used in the present specification may select a more acceptable range of deviation or standard deviation based on optical property, etching property or other properties. One cannot apply one standard deviation to all properties.

The terms “battery pack” and/or “battery” used in the present specification refer re-chargeable and/or reusable power storage components, such as Lithium-ion battery, lead-acid battery or lithium-iron battery. Besides, the terms “battery pack” and/or “battery” are not limited on chemical energy batteries, any re-chargeable power storage components should be applicable to the scope of “battery pack” and/or “battery”. Furthermore, the “battery pack” and/or “battery” used in the present specification can be series or shunt to increase total voltage (e.g., 2V, 6V, 12V, 48V, 480V or any voltage under 1000V) or total power (e.g., 1000 mAh to 1000 Ah or more). The term “battery module” refers to the battery protection circuitry in the following embodiments in combination with the battery pack.

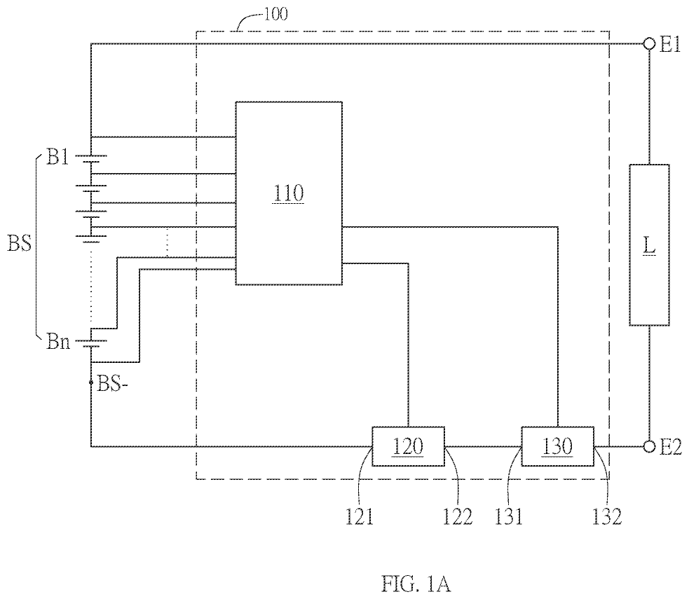

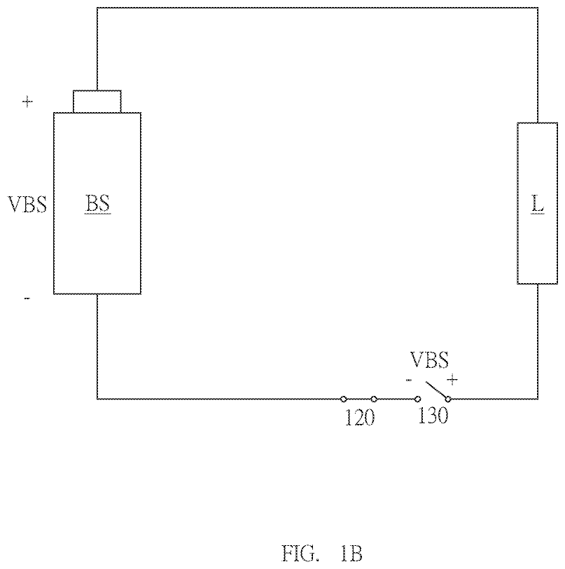

In the first embodiment, refers to FIGS. 1A-1B, FIG. 1A illustrates the battery protection circuitry 100 comprising the first control component 110, the first over-discharged protect switch 120 and the second over-discharged protect switch 130. The first control component 110 is configured to couple to the battery pack BS to read voltage values of each battery B1-Bn in the battery pack BS. The first over-discharged protect switch 120 has the first end 121 configured to couple to the negative pole (BS−) of the battery pack BS, and the second end 122. The second over-discharged protect switch 130 has a third end 131 coupled to the second end 122. When a voltage value of any battery B1-Bn in the battery pack BS is less than an over-discharged default voltage (Vdth), the first control component 110 controls the second over-discharged protect switch 130 to be disconnected prior to the first over-discharged protect switch 120. Wherein the voltage tolerance of the second over-discharged protect switch 130 is higher than the voltage tolerance of the first over-discharged protect switch 120.

More specifically, the first control component 110 can be circuitry that integrating (for example, on printed circuit board) components with computing function (e.g., microprocessor or field programmable logical gate (FPGA)), active elements (e.g., chips for applying clock signal, analog-to-digital converter or like) and passives elements (e.g., inductors, capacitors or resisters). The first control component 110 also can be formed by commercially available chips, such as application specific integrated circuit (ASIC) using for charge/discharge protect. It should be noted that the first control component 110 is not limited by the aforementioned type or example.

The first control component 110 reads voltage values of each battery in the battery pack BS, more specifically, the positive and negative poles of each battery B1-Bn in the battery pack BS can be coupled to the first control component 110 respectively to read the respective voltage of the battery B1-Bn (for example, the voltage value can be read by an analog-to-digital converter). Although not shown in FIG. 1, it should be known that when the input ports of the first control component 110 or the analog-to-digital converter are not enough to match the number of batteries B1-Bn, the first control component 110 can also be sequentially coupled to batteries B1-Bn via a selector or multiplexer to read the voltage of batteries B1-Bn respectively. In the other hand, the battery protection circuitry 100 can integrate temperature sensor or current sensor with the first control component 110. The first control component 110 can monitor parameters (e.g., temperature and/or current) of batteries B1-Bn in the battery pack BS by various sensors. The first control component 110 can control the charge/discharge loop of the battery pack BS to close or open according to the parameters acquired by the sensors.

The first over-discharged protect switch 120 and the second over-discharged protect switch 130 can be but not limited to transistor (e.g., field-effect transistor (FET) or insulated gate bipolar transistor (IGBT)) or relay (e.g., mechanical relay, electromagnetic relay or solid-state relay) or likes. The voltage tolerance of the second over-discharged protect switch 130 is higher/better than the voltage tolerance of the first over-discharged protect switch 120. For example, a relay can be selected to be the second over-discharged protect switch 130 and a FET can be selected to be first over-discharged protect switch 120. It should be noted that the term “voltage tolerance” can refer to the voltage difference between two ends of the switch or the voltage difference to be isolated by the switch. More specifically, higher voltage tolerance indicates the voltage difference between the two ends/sides of the switch that can withstand when disconnecting the circuit loop. However, the voltage tolerance is not limited to the above example, and the voltage tolerance may also be affected by the impedance of the switch and loop current when the switch is turned on.

As shown in FIG. 1, the first end 121 of the first over-discharged protect switch 120 is coupled to the negative pole BS− of the battery pack BS, and the third end 131 of the second over-discharged protect switch 130 is coupled to the second end 122 of the first over-discharged protect switch 120. More specifically, the first over-discharged protect switch 120 is connected with the second over-discharged protect switch 130 in series. It means that when one of the first over-discharged protect switch 120 and the second over-discharged protect switch 130 is turn off, the loop formed by the first over-discharged protect switch 120 and the second over-discharged protect switch 130 will be disconnected. It should be noted that, although FIG. 1 illustrates the first over-discharged protect switch 120 coupled to the negative pole BS− of the battery pack BS and the second over-discharged protect switch 130 coupled to the first over-discharged protect switch 120, a person having ordinary skill in the art will understand that the coupling relationship of the first over-discharged protect switch 120 and the second over-discharged protect switch 130 can be change or adjust. For example, the second over-discharged protect switch 130 can be coupled to the negative pole BS− of the battery pack BS and the first over-discharged protect switch 120 connected with the second over-discharged protect switch 130 in series. Or the second end 122 of the first over-discharged protect switch 120 is indirectly connected with the third end 131 of the second over-discharged protect switch 130 via components such as resisters or inductors.

When battery pack BS discharging (for example, the interface terminals E1 and E2 of the battery protection circuitry 100 are connected with the load L). The voltage/power of the battery B1-Bn in the battery pack BS will decrease due to the load L. When the voltage of any battery B1-Bn is lower than Vdth, the second over-discharged protect switch 130 with high voltage tolerance is disconnected prior to the first over-discharged protect switch 120. For example, the first control component 110 can set a delay time, once second over-discharged protect switch 130 is disconnected, then after the delay time, the first over-discharged protect switch 120 is disconnected. When the second over-discharged protect switch 130 is disconnected, the fourth end 132 of the second over-discharged protect switch 130 and the third terminal 131 directly/indirectly coupled to the negative terminal BS− of the battery pack BS will have the voltage VBS output by the battery pack BS (as shown in FIG. 1B). By disconnecting the second over-discharged protect switch 130 with high voltage tolerance prior to the first over-discharged protect switch 120, a better over-discharged protection can be provided. Besides, if needs than two set of over-discharged protect switches (e.g., according to regulations), the cost of the circuit and components will not increase too much.

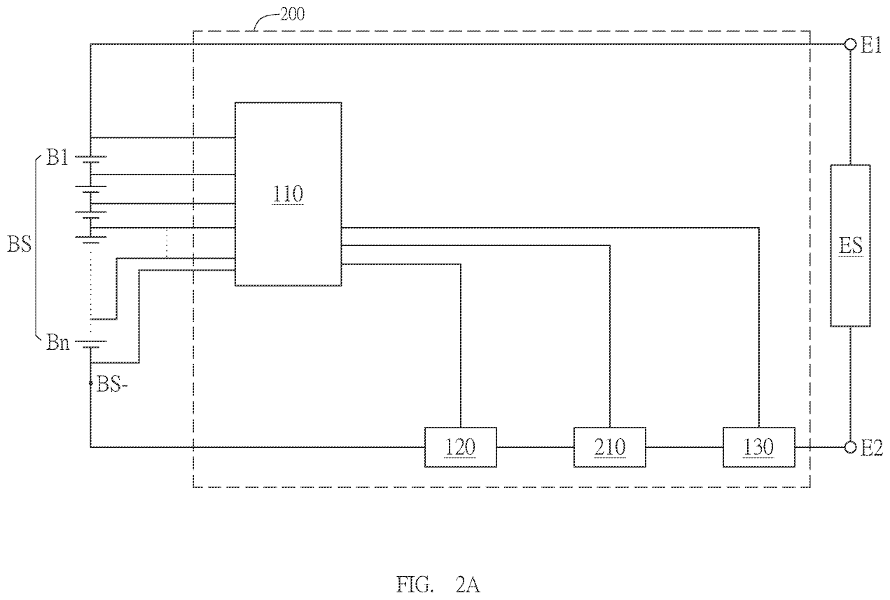

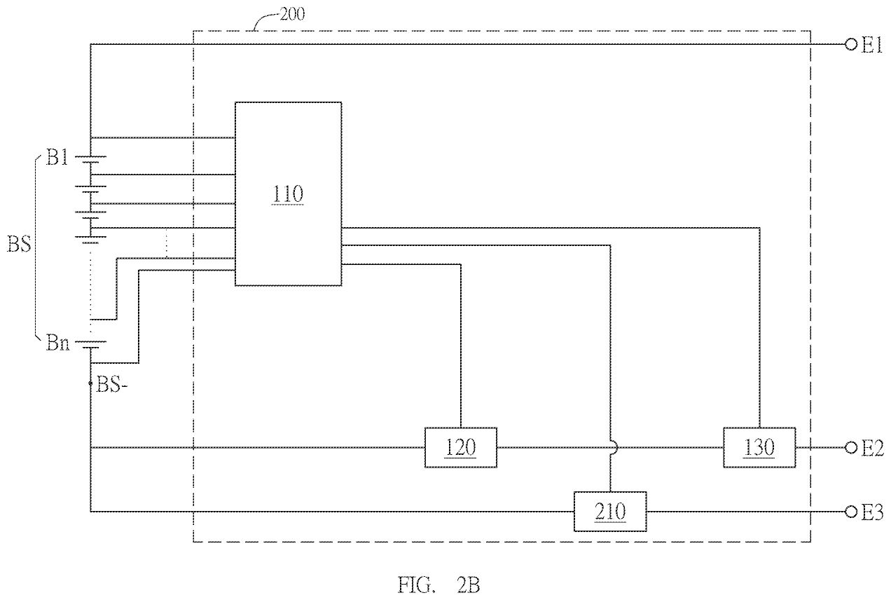

In the second embodiment of the present invention, referring to FIGS. 2A-2B, the battery protection circuitry 200 further comprises the first over-charged protect switch 210 having the fifth end 211 configured to be directly or indirectly coupled to the negative pole BS− of the battery pack BS. When the voltage of any battery B1-Bn in the battery pack BS is larger than the first over-charged voltage (Vcth), the first control component 110 controls the first over-charged protect switch 210 to disconnect. More specifically, the first over-charged protect switch 210 is indirectly coupled to the negative pole BS− of the battery pack BS (via the first over-discharged protect switch 120), and connected with the first over-discharged protect switch 120 and the second over-discharged protect switch 130 in series. When the interface terminals E1 and E2 are coupled to the external power supply ES for charging, the first control component 110 reads the voltage value of battery B1-Bn in battery pack BS. When the voltage of any battery B1-Bn in the battery pack BS is larger than Vcth, the first control component 110 controls the first over-charged protect switch 210 to disconnect to turn off the charging path to avoid damage to battery B1-BN caused by overcharge during charging. In another embodiment, as shown in FIG. 2B, the first over-charged protect switch 210 is directly coupled to the negative pole BS− of the battery pack BS, and the battery protection circuitry 200 has the interface terminal E3. When charging, the external power supply ES is coupled to the interface terminals E1 and E3 (that is, the battery pack BS, the battery protection circuitry 200 and external power supply ES are formed a charging loop through interface terminals E1 and E3). When discharging, external load L can be coupled to interface terminals E1 and E2 (that is, the battery pack BS, the battery protection circuitry 200 and the external load L area formed a discharge loop through the interface terminals E1 and E2). However, the arrangement of the first over-charged protect switch 210 of the present invention is not limited by above examples.

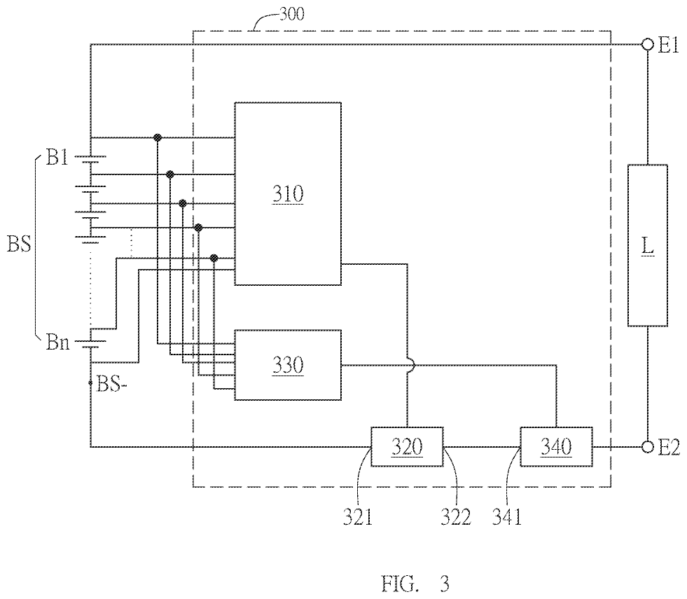

In the third embodiment, referring FIG. 3, FIG. 3 illustrates the battery protection circuitry 300 comprising the first control component 310, the first over-discharged protect switch 320, the second control component 330 and the second over-discharged protect switch 340. The first control component 310 is configured to couple to the battery pack BS to read voltage value of each battery B1-Bn in the battery pack BS. The first over-discharged protect switch 320 has the first end 321 configured to couple to the negative pole BS− of the battery pack BS, and the second end 322. The second control component 330 is configured to couple the battery pack BS to read the voltage values of each battery B1-Bn in the battery pack BS. The second over-discharged protect switch 340 has the third end 341 coupled to the second end 322. when a voltage value of any battery B1-Bn in the battery pack BS is less than a first over-discharged default voltage (Vdth1), the first control component 310 controls the first over-discharged protect switch 320 to be disconnected. When a voltage value of any battery B1-Bn in the battery pack BS is less than a second over-discharged default voltage (Vdth2), the second control component 330 controls the second over-discharged protect switch 340 to be disconnected. Wherein Vdth2 is larger than Vdth1.

More specifically, the first control component 310 and the second control component 330 can be circuitry that integrating (for example, on printed circuit board) components with computing function (e.g., microprocessor or field programmable logical gate (FPGA)), active elements (e.g., chips for applying clock signal, analog-to-digital converter or like) and passives elements (e.g., inductors, capacitors or resisters). The first control component 110 also can be formed by commercially available chips, such as application specific integrated circuit (ASIC) using for charge/discharge protect. It should be noted that the first control component 110 is not limited by the aforementioned type or example. It should be noted that first control component 310 and the second control component 330 can be formed by the same or different architectures.

Compared with the first control component 310, the second control component 330 can be given a stricter protection voltage range and provide the first level protection. More specifically, when the battery pack BS is discharging, the first control component 310 and the second control component 330 measure and monitor the voltage of batteries B1-Bn in the battery pack BS respectively. It can provide the second level of protection while component failure by setting two or more independent control components. It will meet the safety requirements of high specifications (for example, regulations or military/medical batteries). Because Vdth2 is greater than the Vdth1, the second over-discharged protect switch 340 can turn off the discharge loop prior to the first over-discharged protect switch 320. In this embodiment, it is preferable that the voltage tolerance of the second over-discharged protect switch 340 is greater than the voltage tolerance of the first over-discharged protect switch 320.

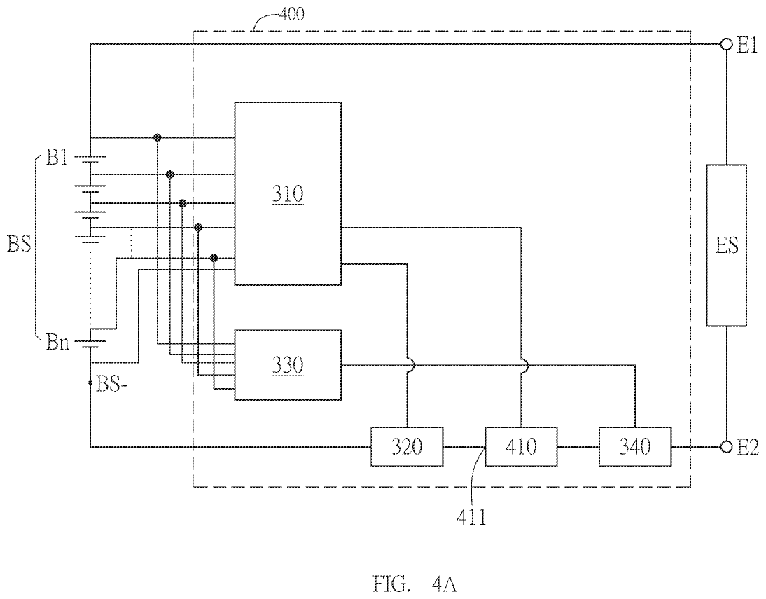

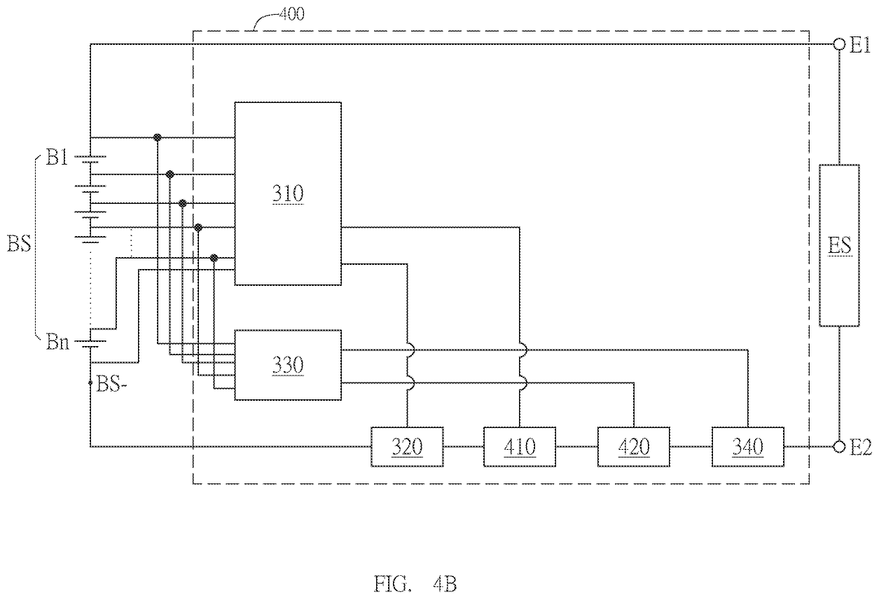

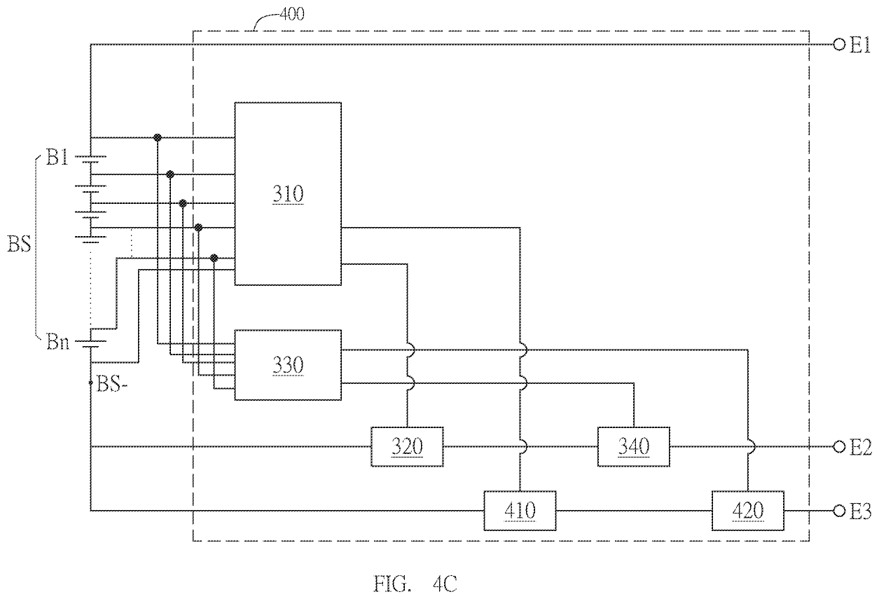

In the fourth embodiment, refer to FIGS. 4A-4B, FIG. 4A illustrates the battery protection circuitry 400 further comprising the first over-charged protect switch 410. The first over-charged protect switch 410 has the fifth end 411 configured to directly or indirectly couple to the negative pole BS− of the battery pack BS. When the voltage of any batterie B1-Bn in the battery pack BS is larger than the first over-charged voltage (Vcth1), the first control component 310 controls the first over-charged protect switch 410 to disconnect. It should be noted that, as shown in FIG. 4B, the second control component 330 also can control the second over-charged protect switch 420 which is directly or indirectly connected to the negative pole BS− of the battery pack BS. When the voltage of any batterie B1-Bn in the battery pack BS is larger than the second over-charged voltage (Vcth2), the second control component 330 controls the second over-charged protect switch 420 to disconnect. In this embodiment, Vcth2 may be less than or equal to Vcth1. In the case that Vcth2 is less than Vcth1, when any battery B1-Bn in the battery pack BS is going to be overcharged, the second over-charged protect switch 420 can be used as the first channel protection to withstand large voltage changes. I In the case that In the case that Vcth2 is equal to Vcth1, one of the first control component 310 and the second control component 330 serves as a backup security to ensure that the overcharge protection can be activated by at least one of the first control component 310 and the second control component 330.

It should be noted that the arrangement of the first over-charged protect switch 410 and the second over-charged protect switch 420 of the invention is not limited to FIG. 4A-4B. The battery protection circuitry 400 can have charging interface terminals E1 and E3 and discharge interface terminals E1 and E2 respectively. The first over-discharged protect switch 320 and the second over-discharged protect switch 340 are arranged at the discharge path, and the first over-charged protect switch 410 and the second over-charged protect switch 420 are arranged at the charging path.

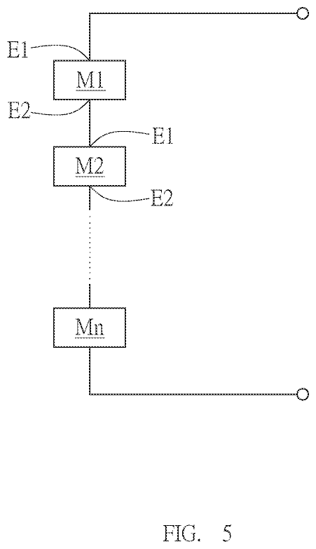

In the fifth embodiment of the invention, after integrating the battery protection circuitry of the invention and the battery pack as a battery module, the battery module can also be used in series/parallel. For example, as shown in FIG. 5, each battery module M1, M2 and Mn has interface terminals E1 and E2 (E1 can be a positive pole and E2 be a negative pole, vice versa), and each battery module is connected in series (the interface terminal E2 of the battery module M1 is connected to the interface terminal E1 of the battery module M2). It should be noted that, a modification made by a person having ordinary skill in the art according to the disclosure should belong to the scope of the present invention.

The foregoing disclosure is merely preferred embodiments of the present invention and is not intended to limit the claims of the present invention. Any equivalent technical variation of the description and drawings of the present invention of the present shall be within the scope of the claims of the present invention.

What is claimed is:

1. A battery protection circuitry comprising:
a first control component configured to couple to a battery pack to read voltage values of each battery in the battery pack;
a first over-discharged protect switch having a first end configured to couple to a negative pole of the battery pack, and a second end; and
a second over-discharged protect switch having a third end coupled to the second end;
when a voltage value of any battery in the battery pack is less than an over-discharged default voltage, the first control component controls the second over-discharged protect switch to be disconnected prior to the first over-discharged protect switch;
wherein the voltage tolerance of the second over-discharged protect switch is higher than the voltage tolerance of the first over-discharged protect switch.

2. The battery protection circuitry of claim 1, further comprising a first over-charged protect switch having a fifth end configured to directly or indirectly couple to the negative pole of the battery pack; when a voltage value of any battery in the battery pack is larger than a first over-charged default voltage, the first control component controls the first over-charged protect switch to be disconnected.

3. The battery protection circuitry of claim 2, wherein the first over-charged protect switch, the first over-discharged protect switch and the second over-discharged protect switch are connecting in series.

4. The battery protection circuitry of claim 1, wherein the second over-discharged protect switch is constituted by relay.

5. A battery protection circuitry comprising:
a first control component configured to couple to a battery pack to read voltage values of each battery in the battery pack;
a first over-discharged protect switch having a first end configured to couple to a negative pole of the battery pack, and a second end;
a second control component configured to couple to the battery pack to read the voltage values of each battery in the battery pack; and
a second over-discharged protect switch having a third end coupled to the second end;
when a voltage value of any battery in the battery pack is less than a first over-discharged default voltage, the first control component controls the first over-discharged protect switch to be disconnected; when a voltage value of any battery in the battery pack is less than a second over-discharged default voltage, the second control component controls the second over-discharged protect switch to be disconnected;
wherein the second over-discharged default voltage is larger than the first over-discharged default voltage.

6. The battery protection circuitry of claim 5, wherein the voltage tolerance of the second over-discharged protect switch is higher than the voltage tolerance of the first over-discharged protect switch.

7. The battery protection circuitry of claim 5, further comprising a first over-charged protect switch configured to directly or indirectly couple to the negative pole of the battery pack; when a voltage value of any battery in the battery pack is larger than a first over-charged default voltage, the first control component controls the first over-charged protect switch to be disconnected.

8. The battery protection circuitry of claim 7, wherein the first over-charged protect switch, the first over-discharged protect switch and the second over-discharged protect switch are connecting in series.

9. The battery protection circuitry of claim 5, wherein the second over-discharged protect switch is constituted by relay.

10. A battery module comprising:
a battery pack; and
the battery protection circuitry of claim 1.

11. A battery module comprising:
a battery pack; and
the battery protection circuitry of claim 5.
